(19) United States
(12) Patent Application Publication
(10) Pub. No.: US 2010/0139317 A1
(43) Pub. Date: Jun. 10, 2010

(54) METHOD OF COOLING A HYDROCARBON STREAM AND AN APPARATUS THEREFOR

(76) Inventors: Francois Chantant, The Hague (NL); Adriaan Johannes Kodde, Amsterdam (NL); Alexandre M C R Santos, The Hague (NL)

Correspondence Address: SHELL OIL COMPANY, P O BOX 2463, HOUSTON, TX, 772522463, US

(21) Appl. No.: 12/630,560

(22) Filed: Dec. 3, 2009

Related U.S. Application Data
(60) Provisional application No. 61/120,086, filed on Dec. 5, 2008.
(60) Provisional application No. 61/138,725, filed on Dec. 18, 2008.

(51) Int. Cl. F25J 3/00; F02C 3/20; F02C 6/00

(52) U.S. Cl. 62/619; 62/618; 60/780; 60/784; 60/39.5

(57) ABSTRACT

A hydrocarbon feed stream is separated in one or more separators to provide a hydrocarbon stream and at least one methane-lean stream comprising a first ethane-rich header feed stream. The hydrocarbon stream is heat exchanged with at least one refrigerant stream to provide at least one cooled hydrocarbon stream and at least one at least partially evapourated refrigerant stream. The first ethane-rich header feed stream is passed to at least one fuel gas header, from which header fuel gas is removed as at least one fuel gas stream.

### CROSS-REFERENCE TO RELATED APPLICATIONS

The present application claims the benefit of U.S. Provisional Applications Nos. 61/120,086 filed 5 Dec. 2008 and 61/138,725 filed 18 Dec. 2008.

### FIELD OF THE INVENTION

The present invention provides a method of cooling a hydrocarbon stream, and an apparatus therefor.

### BACKGROUND OF THE INVENTION

Conventional fuel gas is normally produced from the end gas/liquid separator or the boil-off gas in a liquefaction process and may typically amount to 10-20 mol % of the hydrocarbon feed gas. Fuel gas is comprised primarily of methane, such as >70 mol % methane, more commonly >90 mol %, with the balance being provided by nitrogen and C2+ hydrocarbons such as ethane and propane. The ethane content of the fuel gas does not normally exceed 5 mol %, and is more commonly <2 mol %.

Such fuel gas can be provided to a fuel gas header from which it can be supplied to any number of fuel gas consumers by fuel gas streams. Examples of fuel gas consumers include high quantity consumers such as gas turbines and boilers, as well as lower content consumers such as mixed refrigerant circuits.

### SUMMARY OF THE INVENTION

In a first aspect, the present invention provides a method of cooling a hydrocarbon stream, comprising at least the steps of:

(a) providing a hydrocarbon feed stream;
(b) separating the hydrocarbon feed stream in at least one separator to provide a hydrocarbon stream and at least one methane-lean stream comprising a first ethane-rich header feed stream;
(c) heat exchanging the hydrocarbon stream with at least one refrigerant stream to provide at least one cooled hydrocarbon stream and at least one at least partially evapourated refrigerant stream;
(d) passing the first ethane-rich header feed stream to at least one fuel gas header; and
(e) removing fuel gas from the at least one fuel gas header as at least one fuel gas stream.

In a second aspect, the present invention provides an apparatus for cooling a hydrocarbon stream, the apparatus comprising at least:

at least one separator arranged to receive the hydrocarbon feed stream in a hydrocarbon feed stream line and to separate the hydrocarbon feed stream to provide a hydrocarbon stream in a hydrocarbon stream line and a first ethane-rich header feed stream in a first ethane-rich header feed stream line;

at least one heat exchanger arranged to receive the hydrocarbon stream in a hydrocarbon stream line and a refrigerant stream in a refrigerant stream line to heat exchange the hydrocarbon stream against the refrigerant stream to provide a cooled hydrocarbon stream in a cooled hydrocarbon stream line and an at least partly evaporated refrigerant stream in an at least partly evapourated refrigerant stream line; and

at least one fuel gas header connected to the first ethane-rich header feed stream line to receive the first ethane-rich header feed stream, said at least one fuel gas header being connected to at least one fuel gas stream line to provide at least one fuel gas stream.

### BRIEF DESCRIPTION OF THE DRAWINGS

Embodiments of the present invention will hereinafter be described by way of example only, and with reference to the accompanying non-limiting drawings in which:

FIG. 1 shows a general scheme for a hydrocarbon cooling process, generally involving cooling and liquefying a hydrocarbon feed stream such as natural gas; and

FIG. 2 shows a simplified scheme of first and second separators together arranged to receive the hydrocarbon feed stream and provide therefrom a hydrocarbon stream, and at least one methane-lean stream comprising a first ethane-rich header feed stream.

For the purpose of this description, a single reference number will be assigned to a line as well as a stream carried in that line. Same reference numbers refer to similar components, streams or lines.

### DETAILED DESCRIPTION OF THE INVENTION

In the present specification, the term “one or more” is used interchangeably with the term “at least one”. Both are considered to have the same meaning.

The methods and apparatuses described herein may be used to cool a hydrocarbon stream to provide a cooled hydrocarbon stream, such as a Liquefied Natural Gas (LNG) stream. The hydrocarbon stream may comprise natural gas, or essentially consist of a natural gas stream.

The methods and apparatuses described herein employ one or more ethane-rich header feed streams, which may be used to supply one or more fuel gas headers. Herewith, an ethane-rich source of fuel gas may be provided for one or more fuel gas headers as the first ethane-rich header feed stream from the one or more separators. This may be a particularly advantageous proposition in, for instance, situations when the hydrocarbon feed stream comprises a significant amount of ethane, which may exceed the demands for ethane export.

The hydrocarbon feed stream may be any suitable gas stream to be cooled and liquefied, but is usually a natural gas stream obtained from natural gas or petroleum reservoirs. As an alternative the natural gas stream may also be obtained from another source, also including a synthetic source such as a Fischer-Tropsch process.

Usually a natural gas stream is comprised substantially of methane. Preferably the hydrocarbon feed stream comprises at least 50 mol % methane, more preferably at least 80 mol % methane.

The hydrocarbon feed stream may also contain non-hydrocarbons such as H₂O, N₂, CO₂, Hg, H₂S and other sulphur compounds, and the like. If desired, the hydrocarbon feed stream comprising the natural gas may be pre-treated before cooling and liquefying. This pre-treatment may comprise reduction and/or removal of undesired components such as CO₂ and H₂S or other steps such as early cooling, pre-pressurizing or the like. As these steps are well known to the person skilled in the art, their mechanisms are not further discussed here.

Thus, the term “hydrocarbon feed stream” also includes a composition prior to any treatment, such treatment including cleaning, dehydration and/or scrubbing, as well as any composition having been partly, substantially or wholly treated for the reduction and/or removal of one or more compounds or substances, including but not limited to sulphur, sulphur compounds, carbon dioxide, water, Hg, and one or more C₂+ hydrocarbons.

The hydrocarbon feed stream is one example of a source of an ethane-rich header feed stream which may be used to supply one or more fuel gas headers in a method and apparatus described herein.

Depending on the source, natural gas may contain varying amounts of hydrocarbons heavier than methane such as in particular ethane, propane and the butanes, and possibly lesser amounts of pentanes and aromatic hydrocarbons. The composition varies depending upon the type and location of the gas.

Conventionally, the hydrocarbons heavier than methane are removed as far as efficiently possible from the hydrocarbon feed stream prior to any significant cooling for several reasons, such as having different freezing or liquefaction temperatures that may cause them to block parts of a methane liquefaction plant. C₂+ hydrocarbons can be separated from, or their content reduced in a hydrocarbon feed stream by a demethaniser, which will provide an overhead hydrocarbon stream which is methane-rich and a bottoms methane-lean stream comprising the C₂+ hydrocarbons. The bottoms methane-lean stream may then be passed to a deethaniser to provide an overhead first ethane-rich stream, such as a first ethane-rich header feed stream and a bottoms ethane-lean stream comprising the C₃+ hydrocarbons.

The separation of hydrocarbons heavier than methane from the hydrocarbon feed stream is another example of a source of an ethane-rich header feed stream which may be used to supply one or more fuel gas headers in a method and apparatus described herein. Preferably the first ethane-rich header feed stream is provided from a separator such as a deethaniser, which is an unconventional source of fuel gas.

The fuel gas header is a collection, storage and distribution system for fuel gas. It may be supplied with fuel gas streams from multiple sources. In the method and apparatus described herein, one or more fuel gas headers are provided with fuel gas from a first ethane-rich header feed stream derived from the separation of the hydrocarbon feed stream. It is preferred that the fuel gas in the total of the one or more fuel gas headers, i.e. the total volume provided by all the fuel gas headers in the method and apparatus, comprises greater than 30 mol % ethane, more preferably greater than 40 mol % ethane, even more preferably greater than 50 mol % ethane.

Preferably at least one of said fuel gas streams comprises >30 mol %, more preferably >40 mol %, still more preferably >50 mol % ethane. In such cases, if the fuel gas is required to power a gas turbine, Siemens gas turbines can be used because they are not limited by the quantity of ethane in the fuel gas stream. Conventional industrial gas turbines, such as General Electric Frame 7 gas turbines, are less tolerant to ethane content such that this to be limited to 20 to 25 mol % of the fuel gas stream. A separate fuel gas header may be provided to supply lower ethane content fuel to such gas turbines.

The gas turbines may be used to drive one or more compressors, such as refrigerant compressors, either by direct mechanical drive or by the electrical power generated if the turbine is connected to an electrical generator.

The one or more turbine flue gas streams may be heat exchanged against one or more water streams in a heat exchanger to provide one or more steam streams, such as high pressure steam streams, and one or more cooled turbine flue gas streams. The one or more steam streams, such as high pressure steam streams, may be passed to one or more steam headers, such as one or more high pressure steam headers.

In a further embodiment, the one or more turbine flue gas streams, originating either from gas turbines fuelled by a fuel gas header described herein supplied from the ethane-rich header feed stream or from another fuel gas header supplying lower ethane content fuel gas, may be passed to a combustion device, such as a duct firing device, where it is mixed with a fuel gas stream, and combusted to provide one or more heated flue gas streams. Such a duct firing operation may raise the temperature of the flue gas stream from 650° C. to 800° C. Preferably, the one or more fuel gas streams are provided by the one or more headers supplied from the ethane-rich header feed stream, although a fuel stream from a fuel gas header supplying lower ethane-content fuel gas may also be used. The one or more heated turbine flue gas streams may then be heat exchanged in a heat exchanger against one or more water streams to provide one or more steam streams, preferably high pressure steam streams, and one or more cooled turbine flue gas streams. The one or more steam streams, preferably high pressure steam streams may be supplied to a steam header, such as a high pressure steam header, and used throughout the plant, for instance to power steam turbines to generate mechanical or electrical power.

The one or more fuel gas streams from the one or more fuel gas headers described herein may also be combusted in one or more boilers as boiler fuel gas stream, to provide heat and one or more boiler flue gas streams. Alternatively, a fuel gas stream from a fuel gas header supplying a lower ethane content fuel gas may also be used to fuel the boilers. Heat exchanging at least one of the one or more boiler flue gas streams against one or more water streams may provide at least one steam stream, such as a high pressure steam stream, and one or more cooled flue gas streams. The high pressure steam stream may be passed to a high pressure steam header. Conventional industrial boilers are not limited by the quantity of ethane in their fuel gas.

Alternatively, the one or more boiler flue gas streams, originating either from boilers fuelled by a fuel gas header described herein supplied from the ethane-rich header feed stream or from a fuel gas header supplying lower ethane content fuel gas, may be passed to a combustion device, such as a duct firing device, to increase the temperature of the flue gas to provide one or more heated boiler flue gas streams. The one or more heated boiler flue gas streams may then be heat exchanged in a heat exchanger against one or more water streams to provide one or more steam streams, preferably high pressure steam streams, and one or more cooled boiler flue gas streams. The one or more steam streams, preferably high pressure steam streams may be supplied to a steam header, such as a high pressure steam header, and used throughout the plant, for instance to power steam turbines to generate one or both of mechanical and electrical power.

To provide a partially liquefied hydrocarbon stream, the hydrocarbon stream should be cooled. Such initial cooling could be provided by a number of methods known in the art. One example is by passing the hydrocarbon stream against a refrigerant, such as a single refrigerant, e.g. propane, in a pre-cooling refrigerant circuit or a first fraction of a mixed refrigerant of a mixed refrigerant circuit, in one or more pre-cooling heat exchangers, to provide a partially liquefied hydrocarbon stream, preferably at a temperature below 0° C.

The single or mixed refrigerant circuit will comprise one or more refrigerant compressors to compress the refrigerant stream. The refrigerant compressors may be driven by one or more gas turbine drivers fuelled by fuel gas from the one or more fuel gas headers as disclosed herein or by other means, such as electrical driver motors.

Preferably, any such pre-cooling heat exchangers could comprise a pre-cooling stage, and one or more main heat exchangers used in liquefying any fraction of the hydrocarbon stream could comprise one or more main and/or sub-cooling cooling stages.

In this way, the method and apparatus disclosed herein may involve two or more cooling stages, each stage having one or more steps, parts etc. For example, each cooling stage may comprise one to five heat exchangers. The or a fraction of a hydrocarbon stream and/or the mixed refrigerant may not pass through all, and/or all the same, heat exchangers of a cooling stage.

In one embodiment, the hydrocarbon liquefying process comprises two or three cooling stages. A pre-cooling stage is preferably intended to reduce the temperature of a hydrocarbon feed stream to below 0° C., usually in the range −20° C. to −70° C.

A main cooling stage is preferably separate from the pre-cooling stage. That is, the main cooling stage comprises one or more separate heat exchangers.

A main cooling stage is preferably intended to reduce the temperature of a hydrocarbon stream, usually at least a fraction of a hydrocarbon stream cooled by a pre-cooling stage, to below −100° C.

Heat exchangers for use as the one or more pre-cooling or the one or more main heat exchangers are well known in the art. At least one of the main heat exchangers is preferably a spool-wound cryogenic heat exchanger known in the art. Optionally, a heat exchanger could comprise one or more cooling sections within its shell, and each cooling section could be considered as a cooling stage or as a separate ‘heat exchanger’ to the other cooling locations.

In yet another embodiment described herein, one or more fractions of a mixed refrigerant stream may be passed through one or more heat exchangers, preferably two or more of the pre-cooling and main heat exchangers described hereinabove, to provide one or more cooled mixed refrigerant streams.

The mixed refrigerant in a mixed refrigerant circuit may be formed from a mixture of two or more components selected from the group comprising: nitrogen, methane, ethane, ethylene, propane, propylene, butanes, pentanes, etc. The present invention may involve the use of one or more other refrigerants, in separate or overlapping refrigerant circuits or other cooling circuits.

In one embodiment of the present invention, the method of cooling, preferably liquefying a hydrocarbon stream comprises one refrigerant circuit comprising one mixed refrigerant.

A mixed refrigerant or a mixed refrigerant stream as referred to herein comprises at least 5 mol % of two different components. More preferably, the mixed refrigerant comprises two or more of the group comprising: nitrogen, methane, ethane, ethylene, propane, propylene, butanes and pentanes. A common composition for a mixed refrigerant can be:

| | |
|---|---|
| Nitrogen | 0-10 mol % |
| Methane (C1) | 30-70 mol % |
| Ethane (C2) | 30-70 mol % |
| Propane (C3) | 0-30 mol % |
| Butanes (C4) | 0-15 mol % |

The total composition comprises 100 mol %.

It is apparent that such a mixed refrigerant composition is suitable as a fuel gas stream. A bleed stream from an ethane-rich mixed refrigerant may be used as one ethane-rich header feed stream. For instance, an ethane-rich mixed refrigerant bleed stream may be drawn from one or more of the pre-cooling or one or more of the main-cooling heat exchangers and passed to one or more fuel gas headers.

In another embodiment, the cooled hydrocarbon stream may be a liquefied hydrocarbon stream. Preferably, the method is for liquefying natural gas to provide liquefied natural gas.

After liquefaction, the liquefied hydrocarbon stream may be further processed, if desired. As an example, the obtained LNG may be depressurized by means of a Joule-Thomson valve or by means of a cryogenic turbo-expander.

In another embodiment disclosed herein, the liquefied hydrocarbon stream is passed through an end gas/liquid separator such as an end-flash vessel to provide an end-flash gas stream overhead and a liquid bottom stream, the latter optionally for storage in a storage tank as the liquefied product, such as LNG. The end-flash gas may be compressed in an end-flash gas compressor to provide a compressed end-flash gas stream and cooled to provide a cooled end-flash gas stream, which may be passed to the one or more fuel gas headers.

The cooled end-flash gas is derived from the end gas/liquid separator. The composition of the cooled end-flash gas will thus be determined by the composition of the liquefied hydrocarbon. The liquefied hydrocarbon, such as LNG, will be at a required product specification, usually having an ethane content of less than 10 mol %. In this case, rather than providing an ethane-rich header feed stream, an ethane-depleted header feed stream would be provided.

Preferably, the cooled hydrocarbon stream provided by the method and apparatus described herein may be used to provide a liquefied hydrocarbon stream which may be stored in one or more storage tanks.

The boil-off gas stream from the one or more liquefied hydrocarbon storage tanks can provide a further source of fuel gas, for the fuel gas header. The boil-off gas is the gas vapourised from the liquefied storage tanks due to temperature fluctuations or imperfect insulation. The composition of the boil-off gas will thus be determined by the composition of the liquefied hydrocarbon. The liquefied hydrocarbon, such as LNG, will be at a required product specification, usually having an ethane content of less than 10 mol %. In this case, rather than providing an ethane-rich header feed stream, an ethane-depleted header feed stream could be provided.

In a further embodiment, where a fraction, preferably the coldest fraction, of the refrigerant stream passes through a suitable gas/liquid separator, at least a fraction of the gaseous overhead stream from this gas/liquid separator could be combined with the end-flash gas stream from the end gas/liquid separator or a stream derived therefrom, and optionally boil-off gas from the storage tank, to provide a combined stream for compression and supply to one or more fuel gas headers.

Furthermore, the fuel gas stream described herein may be used to provide duct firing for a flue gas stream. For instance, a flue gas stream, such as a turbine flue gas stream or a boiler flue gas stream may be passed to a combustion device where it is mixed with a fuel gas stream as described herein, and combusted to provide a heated flue gas stream.

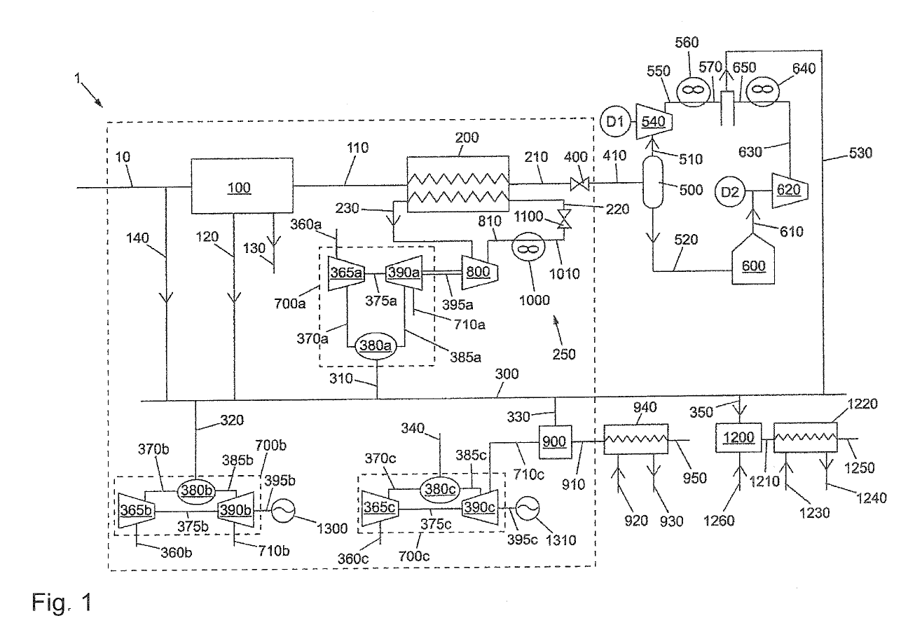

Referring to the drawing, FIG. 1 shows a general scheme 1 for a method of cooling a hydrocarbon stream 110. As part of a hydrocarbon cooling process, and prior to any major cooling, an initial hydrocarbon feed stream 10, which may be a natural gas stream, is separated in one or more separators 100 to reduce and/or remove many of the heavier hydrocarbons therefrom thereby providing the hydrocarbon stream 110 to be cooled and one or more methane-lean streams 120, 130. The one or more methane lean streams 120, 130 comprise a first ethane-rich header feed stream 120.

A common form of such separation is termed ‘natural gas liquids’ (NGL) extraction, in which proportions of C₂+ hydrocarbons are fractionated in the one or more separators 100, such as one or more fractionation columns, to provide a methane-enriched hydrocarbon stream as hydrocarbon stream 110 which is subsequently cooled, and one or more single or multi-component streams for the C₂+ components, such as the first ethane-rich header feed stream 120 and optionally further methane-lean streams 130, such as NGL and LPG product streams.

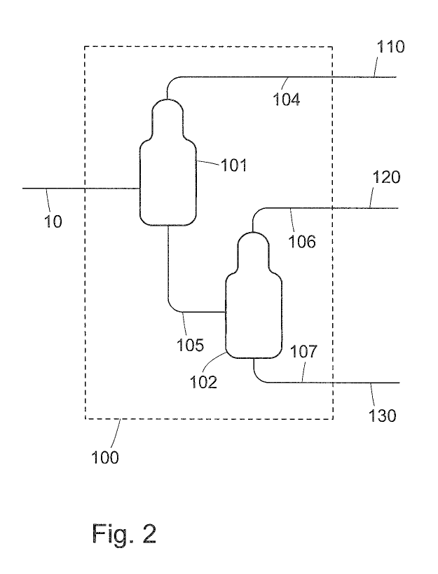

A simplified example of the at least one separator 100 is presented in FIG. 2. The at least one separator in the example of FIG. 2 comprises a first separator 101 and a second separator 102. The first separator 101 is arranged to receive the hydrocarbon feed stream 10 and to separate the hydrocarbon feed stream 10 into a first light stream 104, which may be discharged from the at least one separator in the form of the hydrocarbon stream 110, and a first heavy stream 105. The first light stream 104 leaves the first separator in vaporous form, the first heavy stream 105 in liquid form. The second separator 102 is arranged to receive the first heavy stream 105, and to separate it into a second light stream 106 and a second heavy stream 107. The second light stream 106 leaves the second separator 102 in vaporous form, while the second heavy stream 107 leaves the second separator 102 in liquid form. The second light stream 106 may be discharged from the at least one separator as one of the methane-lean streams, suitably in the form of the first ethane-rich header feed stream 120. The second heavy stream 107 may be discharged in the form of another one of the methane-lean streams, suitably as an ethane-lean stream 130 such as an LPG product stream.

The first separator 101 may be provided in the form of a demethanizer. The first light stream 104 may be in the form of a methane-rich stream, while the first heavy stream 105 may be in the form of a methane-lean stream. The second separator 102 may be provided in the form of a deethanizer. The second light stream 106 may be in the form of an ethane-rich stream while the second heavy stream 107 is preferably in the form of an ethane-lean stream.

Back to FIG. 1, a portion of the hydrocarbon feed stream 10 may also be removed as second ethane-rich header feed stream 140 and passed to the one or more fuel gas headers 300. This is discussed in greater detail below.

The hydrocarbon stream 110 to be cooled may then be passed through one or more heat exchangers 200 in a refrigerant circuit 250. The one or more heat exchangers 200 can be in series, parallel, or both, in a manner known in the art.

For simplicity, FIG. 1 shows use of a single refrigerant circuit 250, although the present invention is not limited thereto. The use of a single mixed refrigerant circuit to provide cooling to two or more different sets of heat exchangers is known in the art, and an example is shown in WO 96/33379 A1 incorporated herein by way of reference. Alternatively, the method may involve one or more other, further or separate refrigerant circuits to provide other, further or separate cooling to one or more of the streams. The method and apparatus disclosed herein is not limited by the nature of arrangement of the refrigerant circuit or circuits.

Cooling of the hydrocarbon stream 110 in the one or more heat exchangers 200 may be provided by one or more refrigerant streams 220 in the one or more refrigerant circuits 250. Each refrigerant circuit may comprise one or more refrigerant compressors 800, one or more coolers 1000, one or more expansion devices 1100 and one or more heat exchangers 200.

The hydrocarbon stream 110 is heat exchanged against the one or more refrigerant streams 220 to provide at least one cooled hydrocarbon stream 210 and one or more at least partially evapourated refrigerant streams 230. Preferably the cooled hydrocarbon stream 210 is a liquefied hydrocarbon stream, such as LNG.

At least a fraction of the one or more at least partially evapourated refrigerant streams 230 can be compressed in the one or more refrigerant compressors 800 to provide one or more compressed refrigerant streams 810. The one or more compressed refrigerant streams 810 may be cooled in one or more coolers 1000, such as air or water coolers, to provide one or more cooled refrigerant streams 1010. At least a fraction of the one or more refrigerant streams 1010 may be expanded in one or more refrigerant expansion devices 1100, such as an expander or Joule-Thomson valve, to provide the one or more refrigerant streams 220 used to cool the hydrocarbon stream 110.

The one or more heat exchangers 200 in one or more refrigerant circuits 250 may form one or more of a pre-cooling stage, a main cooling stage and a sub-cooling stage.

Preferably, any pre-cooling stage cools the hydrocarbon feed stream 10 to below 0° C., such as between −20° C. and −70° C., preferably either between −20° C. and −45° C., or between −40° C. and −70° C., to provide a partially liquefied hydrocarbon stream in a manner known in the art. Cooling may be carried out in one or more pre-cooling heat exchangers and may be provided by a single or mixed refrigerant in a manner known in the art.

The liquefied hydrocarbon stream from any pre-cooling stage may be passed to a main cooling stage comprising one or more main heat exchangers, preferably a main cryogenic heat exchanger. Such a main cryogenic heat exchanger may also perform the function of a sub-cooling stage.

Thus, it is preferred that: the one or more heat exchangers 200 may comprise one or more pre-cooling heat exchangers in a first cooling stage, and the one or more refrigerant streams 220 comprise a first fraction cooled refrigerant. It is also preferred that: the one or more heat exchangers 200 further comprise one or more main heat exchangers in a main cooling stage, the one or more refrigerant streams 220 further comprise one or more second fraction mixed refrigerant streams, and the one or more cooled hydrocarbon streams 210 comprise a liquefied hydrocarbon stream.

The one or more heat exchangers 200 provide one or more cooled, preferably liquefied, hydrocarbon streams 210.

As illustrated in FIG. 1, the apparatus may further comprise:

an expansion device 400 connected to the cooled hydrocarbon stream line carrying the cooled hydrocarbon stream 210, arranged to expand the cooled hydrocarbon stream 210 to provide an expanded cooled hydrocarbon stream 410 in an expanded cooled hydrocarbon stream line;

an end gas/liquid separator 500 connected to the expanded cooled hydrocarbon stream line to separate the expanded cooled hydrocarbon stream 410 into an end-flash gas stream 510 in an end-flash gas stream line and a liquid bottom stream 520 in a liquid bottom stream line;

an end-flash compressor 540 connected to the end-flash gas stream line to compress the end-flash gas stream 510 to provide a compressed end-flash gas stream 550 in a compressed end-flash gas stream line;

a third ethane-rich fuel gas feed line 530 receiving at least a portion of the compressed end-flash gas stream 550 and passing it to the at least one fuel gas header 300. The end-flash gas stream is typically an ethane-depleted stream as it is derived from the hydrocarbon stream 110 downstream of the one or more separators 100.

An optional end-flash gas ambient heat exchanger 560, such as a cooler, may be connected to the compressed end-flash gas stream line to exchange heat between the end-flash gas stream and ambient to provide a heat exchanged, optionally cooled, end-flash gas stream 570 in a heat exchanged end-flash gas stream line, prior to passing it to the third ethane-rich fuel gas feed line 530.

The method of cooling the hydrocarbon stream may further comprise the steps of:

(g) passing the cooled hydrocarbon stream 210 through an expansion device 400 to provide an expanded cooled hydrocarbon stream 410;
(h) separating the expanded cooled hydrocarbon stream 410 in an end gas/liquid separator 500 into an end-flash gas stream 510 and a liquid bottom stream 520;
(i) compressing the end-flash gas stream 510 in an end-flash compressor 540 to provide a compressed end-flash gas stream 550;
(j) optionally heat exchanging, such as cooling, the compressed end-flash gas stream 550 against ambient to provide a heat exchanged, preferably cooled, end-flash gas stream 570;
(k) passing at least a part of the compressed and/or cooled end-flash gas stream 570 to the fuel gas header as an ethane-depleted header feed stream 530.

After passing through the one or more heat exchangers 200, the cooled hydrocarbon stream 210 may then be passed through an expansion device 400 such as a Joule-Thomson valve, to provide an expanded cooled hydrocarbon stream 410. The expanded cooled hydrocarbon stream 410 may then be passed to an end gas/liquid separator 500, which may be an end-flash vessel. The end gas/liquid separator 500 separates the expanded cooled hydrocarbon stream 410 into an end-flash gas stream 510 overhead and a liquid bottom stream 520. The liquid bottom stream 520 may be passed into a storage tank 600, such as an LNG storage tank.

End-flash gas stream 510 may be compressed in an end-flash compressor 540, driven by an end-flash driver D1, to provide a compressed end-flash gas stream 550. The compressed end-flash gas stream 550 may then be cooled in an end-flash cooler 560, such as an air or water cooler, to provide a cooled end-flash gas stream 570. At least a part of the end-flash gas stream 570 may be passed to at least one of the one or more fuel gas headers 300, as ethane-depleted header feed stream 530.

The method of cooling the hydrocarbon stream may further comprise the steps of:

(l) passing the liquid bottom stream 520 into a storage tank 600;
(m) removing boil-off gas from the storage tank 600 as a boil-off gas stream 610;
(n) compressing the boil-off gas stream 610 in a boil-off gas compressor 620 to provide a compressed boil-off gas stream 630;
(o) optionally heat exchanging the compressed boil-off gas stream 630 against ambient, for instance cooling the compressed boil-off gas stream 630 in a boil-off gas cooler 640 to provide a cooled boil-off gas stream 650; and
(p) passing at least a part of the cooled boil-off gas stream 650 to the fuel gas header 300 as ethane-depleted header feed stream 530.
Step (o) is advantageous when the boil-off gas stream 610 compressed in step (n) is provided at or about the operating pressure of the one or more fuel gas headers 300, for instance at a pressure in the range of 20 to 40 bara. However, step (o) may be optional.

In an alternative embodiment not shown in FIG. 1, the boil-off gas stream 610 may be compressed to a pressure less than the operating pressure of the one or more fuel gas headers 300. In this case, the compressed boil-off gas stream 630 may be passed to an intermediate stage of the end-flash gas compressor 540, where it may be combined with partially compressed end-flash gas to provide a compressed combination of the partially compressed end-flash gas stream and compressed boil-off gas stream. This stream may then be passed to the end-flash gas cooler as normal.

The liquid bottom stream 520 from the end gas/liquid separator 500, which may be LNG, can produce vapour during storage in storage tank 600 if the temperature rises about its dew point. Such vapour is called boil-off gas. Any boil-off gas can be removed from the storage tank 600 through boil-off gas stream 610. Boil-off gas stream 610 may be compressed in a boil-off gas compressor 620, driven by a boil-off gas driver D2, to provide a compressed boil-off gas stream 630. The compressed boil-off gas stream 630 may be cooled in a boil-off gas cooler 640, such as an air or water cooler, to provide a cooled boil-off gas stream 650. At least a part of the cooled boil-off gas stream 650 may be passed to at least one of the one or more fuel gas headers 300, as ethane-depleted header feed stream 530. FIG. 1 shows a part of the end-flash gas stream 570 being combined with a part of the cooled boil-off gas stream 650 to provide ethane-depleted header feed stream 530.

Alternatively, the compressed boil-off gas stream 630 may be passed to an intermediate stage of the end-flash compressor 540 to provide the compressed end-flash gas stream 550 as a compressed combination of the end-flash gas stream and compressed boil-off gas stream 630.

In a further alternative embodiment not shown in FIG. 1, the cooled boil-off gas stream 650 may be liquefied by further cooling, for example by heat exchange against end-flash gas stream 510 and returned to storage tank 600.

Ethane-depleted header feed stream 530 may be used to adjust the composition of the one or more fuel gas headers 300. By increasing the proportion of the ethane depleted header feed stream 530 added to the one or more fuel gas headers 300, the ethane content may be reduced.

Alternatively or additionally, the ethane-depleted header feed stream 530 may be sent to another fuel gas header having a lower ethane content, which may be used to supply those pieces of equipment which are not tolerant to higher ethane contents, such as conventional gas turbines.

FIG. 1 shows a number of fuel gas streams 310, 320, 330, 340 and 350 drawn from fuel gas header 300. These fuel gas streams may be passed to one or more different fuel gas consumers 700a, 700b, 700c, 900, 1200.

Users of the fuel gas streams 310, 320, 340 may be one or more gas turbines. For instance, first, second and third gas turbines, 700a, 700b and 700c may be fuelled by first, second and third fuel gas streams 310, 320 and 340, which are turbine fuel gas streams. First, second and third gas turbines are supplied with first, second and third oxidant streams 360a, 360b and 360c respectively, which can comprise oxygen, such as first, second and third air streams. The first, second and third oxidant streams 360a, 360b and 360c are passed to the first, second and third turbine compressors 365a, 365b and 365c respectively, where they are compressed to provide first, second and third compressed oxidant streams 370a, 370b and 370c respectively. First, second and third turbine compressors 365a, 365b and 365c may be mechanically connected to first, second and third turbine expanders 390a, 390b, 390c respectively, for instance by first, second and third connecting shafts 375a, 375b, 375c respectively.

The first, second and third compressed oxidant streams 370a, 370b and 370c are passed to first, second and third combustion chambers 380a, 380b, 380c respectively, where they may be mixed with the first, second and third turbine fuel gas streams 310, 320, 340 and ignited. The combustion reaction produces first, second and third combustion product streams 385a, 385b and 385c from first, second and third combustion chambers 380a, 380b and 380c respectively, and these streams are passed to first, second and third turbine expanders 390a, 390b and 390c, where their expansion is used to provide useful work to drive first, second and third shafts 395a, 395b and 395c respectively and first, second and third turbine flue gas streams 710a, 710b and 710c are produced.

The one or more gas turbines 700a, 700b, 700c may be used to provide one or both of mechanical and electrical power. As shown in FIG. 1, first gas turbine 700a is connected to a compressor 800, such as a refrigerant compressor, via first drive shaft 395a. Second gas turbine 700b is shown to be connected to first electric generator 1300 by second drive shaft 395b. Similarly, third gas turbine 700c is shown to be connected to a second electric generator 1310 by third drive shaft 395c.

The first and second turbine fuel gas streams 310 and 320 are drawn from fuel gas header 300. When these fuel gas streams comprise higher ethane contents, such as >30 mol %, then first and second gas turbines 700a, 700b may be Siemens gas turbines. Third turbine fuel gas stream 340 is drawn from another source, such as a fuel gas header other than fuel gas header 300. If third turbine fuel gas stream 340 comprises lower ethane contents, such as <25 mol %, preferably <20 mol %, more preferably <15 mol %, even more preferably <10 mol % ethane, then it may be used to fuel a conventional industrial gas turbine, such as a GE Frame 7 gas turbine.

In a further embodiment (not shown in FIG. 1), the turbine flue gas stream may be passed to a heat exchanger to extract the thermal energy from the flue gas in a combined cycle process, for instance by heating a water stream to provide a heated water, more preferably a steam stream. A combined cycle process may be used with gas turbines fuelled by the gas header described herein having a higher ethane content, or a gas header having a lower ethane content.

In another embodiment, a fuel gas stream described herein may be used to supply fuel to one or more boilers in the form of a boiler fuel gas stream. FIG. 1 shows fifth fuel gas stream 350 from fuel gas header 300 being provided to boiler 1200. Combustion of the fifth fuel gas stream 350 provides a boiler flue gas stream 1210, which may be sent to boiler heat exchanger 1220. Boiler heat exchanger 1220 may also be provided with a first water stream 1230, which when heated against the boiler fuel gas stream 1210, provides a first heated water stream 1240, such as a steam stream, more preferably a high pressure steam stream, and a cooled boiler flue gas stream 1250. Such a steam stream may be sent to a steam header, such as a high pressure steam header, or sent directly to a consumer of a steam stream, such as a steam turbine.

Furthermore, the fuel gas stream described herein may be used to provide duct firing for a flue gas stream. For instance, a flue gas stream, such as a turbine flue gas stream or a boiler flue gas stream may be passed to a combustion device, where it is mixed with a fuel gas stream, such as the fuel gas stream described herein, and combusted to provide a heated flue gas stream. Such a duct firing operation may raise the temperature of the flue gas stream from 650° C. to 800° C. The heated flue gas stream may then be passed to a heat exchanger where it is cooled against a water stream, to provide a cooled flue gas stream and a heated water stream, more preferably a steam stream, even more preferably a high pressure steam stream.

FIG. 1 shows the third gas turbine 700c, which is supplied with the third fuel gas stream 340 provided from a source other than fuel gas header 300 described herein. If this fuel gas header comprises fuel gas with a low ethane content, e.g. <25 mol % ethane, then the third gas turbine may be a GE Frame 7 gas turbine. The third fuel gas stream 340 may, however, have a high ethane content e.g. >30 mol % ethane, such that the third gas turbine may be a Siemens gas turbine. In either case, the third turbine flue gas stream 710c may be passed to a combustion device 900, such as a duct firing device, which may be integrated with, or separate from, the third gas turbine 700c. The combustion device 900 may be supplied with a fourth fuel gas stream 330, which is shown being supplied by fuel gas header 300, although a separate fuel gas source may be used. The third turbine flue gas stream 710c is heated in the combustion device 900 by the combustion of the fuel gas from the fourth fuel gas stream 330 to provide a heated turbine flue gas stream 910.

The heat from the heated turbine flue gas stream 910 may be extracted in a turbine heat exchanger 940, for instance by heat exchange against a second water stream 920, to provide a heated second water stream 930, which is preferably a steam stream, even more preferably a high pressure steam stream, and a cooled turbine flue gas stream 950. The heated second water stream 930 may then be passed to an appropriate header, such as a steam header when a steam stream is produced.

The person skilled in the art will understand that the present invention can be carried out in many various ways without departing from the scope of the appended claims.

What is claimed is:

1. A method of cooling a hydrocarbon stream comprising natural gas, the method comprising at least the steps of:
(a) providing a hydrocarbon feed stream;
(b1) separating the hydrocarbon feed stream in a first separator in the form of a demethanizer to provide a hydrocarbon stream in the form of a methane-rich stream, and at least one methane-lean stream comprising a first ethane-rich header feed stream;
(b2) separating the methane-lean stream in a second separator in the form of a deethanizer downstream of the first separator, to provide the first ethane-rich header feed stream and at least one ethane-lean stream;
(c) heat exchanging the methane-rich stream with at least one refrigerant stream to provide at least one cooled hydrocarbon stream and at least one at least partially evaporated refrigerant stream;
(d) passing the first ethane-rich header feed stream to at least one fuel gas header;
(e) removing fuel gas from the at least one fuel gas header as at least one fuel gas stream; and
(x) firing at least one of a gas turbine with at least one turbine fuel gas stream comprising the at least one fuel gas stream and a boiler with at least one boiler fuel gas stream comprising the at least one fuel gas stream.

2. The method of claim 1, wherein the fuel gas in the total of the at least one fuel gas header comprises at least 30 mol % ethane.

3. The method of claim 1, further comprising the step of:
(f) passing at least a portion of the hydrocarbon feed stream to the at least one fuel gas header as a second ethane-rich header feed stream.

4. The method of claim 1, further comprising the steps of
(g) passing the cooled hydrocarbon stream through an expansion device to provide an expanded cooled hydrocarbon stream;
(h) separating the expanded cooled hydrocarbon stream in an end gas/liquid separator into an end-flash gas stream and a liquid bottom stream;
(i) compressing the end-flash stream in an end-flash compressor to provide a compressed end-flash gas stream;
(k) passing at least a part of the compressed end-flash gas stream to the fuel gas header as an ethane-depleted header feed stream.

5. The method of claim 4, comprising a step (j) after step (h) and prior to step (k) wherein step (j) comprises:
(j) heat exchanging the compressed end-flash gas stream against ambient.

6. The method of claim 4, further comprising the steps of:
(l) passing the liquid bottom stream into a storage tank;
(m) removing boil-off gas from the storage tank as a boil-off gas stream; and
(n) compressing the boil-off gas stream to provide a compressed boil-off gas stream; and
(p) passing at least a part of the compressed boil-off gas stream to the fuel gas header as ethane-depleted header feed stream.

7. The method of claim 6, comprising a step (o) after step (n) and prior to step (p) wherein step (o) comprises:
(o) heat exchanging the compressed boil-off gas stream against ambient.

8. The method of claim 6, wherein the compressing of the boil-off gas comprises passing the boil-off gas through a boil-off gas compressor and subsequently passing the compressed boil-off gas stream to an intermediate stage of the end-flash compressor to provide the compressed end-flash gas stream.

9. The method of claim 1, further comprising the step of:
(q) firing at least one gas turbine with at least one turbine fuel gas stream to provide at least one turbine flue gas stream and generate at least one of electrical power and mechanical power, wherein the at least one turbine fuel gas stream comprises the at least one fuel gas stream.

10. The method of claim 9, further comprising the step of:
(r) driving a compressor with the at least one of said electrical power and mechanical power generated in step (q).

11. The method of claim 10, wherein the compressor is comprised in a refrigerant circuit, further comprising a step of circulating the at least one refrigerant stream of step (c) in the refrigerant circuit comprising compressing an at least partially evaporated refrigerant stream with the compressor.

12. The method of claim 9, further comprising the step of passing at least one turbine flue gas stream to a combustion device to increase the flue gas temperature to provide at least one heated turbine flue gas stream.

13. The method of claim 1, further comprising the steps of:
(s) combusting the at least one fuel gas stream in at least one boiler to provide at least one boiler flue gas stream; and
(t) heat exchanging the at least one boiler flue gas stream against a water stream to provide at least one steam stream and at least one cooled flue gas stream.

14. The method of claim 1, wherein the at least one refrigerant stream is circulated in at least one refrigerant circuit, the at least one refrigerant circuit comprising at least one compressor, at least one cooler, at least one expansion device, and at least one heat exchanger, said method further comprising the steps of:
(u) compressing at least a fraction of the at least one at least partially evaporated refrigerant stream in the at least one refrigerant compressor to provide at least one compressed refrigerant stream;
(v) cooling the at least one compressed refrigerant stream in the at least one cooler to provide at least one cooled refrigerant stream; and
(w) expanding at least a fraction of the at least one cooled refrigerant stream in the at least one refrigerant expansion device to provide at least one refrigerant stream.

15. A method of cooling a hydrocarbon stream, comprising at least the steps of:
(a) providing a hydrocarbon feed stream;
(b) separating the hydrocarbon feed stream in at least one separator to provide a hydrocarbon stream and at least one methane-lean stream comprising a first ethane-rich header feed stream;
(c) heat exchanging the hydrocarbon stream with at least one refrigerant stream to provide at least one cooled hydrocarbon stream and at least one at least partially evapourated refrigerant stream;
(d) passing the first ethane-rich header feed stream to at least one fuel gas header; and
(e) removing fuel gas from the at least one fuel gas header as at least one fuel gas stream.

16. The method of claim 15, wherein the fuel gas in the total of the at least one fuel gas header comprises at least 30 mol % ethane.

17. The method of claim 15, further comprising the step of:
(f) passing at least a portion of the hydrocarbon feed stream to the at least one fuel gas header as a second ethane-rich header feed stream.

18. The method of claim 15, further comprising the steps of
(g) passing the cooled hydrocarbon stream through an expansion device to provide an expanded cooled hydrocarbon stream;
(h) separating the expanded cooled hydrocarbon stream in an end gas/liquid separator into an end-flash gas stream and a liquid bottom stream;
(i) compressing the end-flash stream in an end-flash compressor to provide a compressed end-flash gas stream;
(k) passing at least a part of the compressed end-flash gas stream to the fuel gas header as an ethane-depleted header feed stream.

19. The method of claim 18, comprising a step (j) after step (h) and prior to step (k) wherein step (j) comprises:
(j) heat exchanging the compressed end-flash gas stream against ambient.

20. The method of claim 18, further comprising the steps of:
(l) passing the liquid bottom stream into a storage tank;
(m) removing boil-off gas from the storage tank as a boil-off gas stream;
(n) compressing the boil-off gas stream to provide a compressed boil-off gas stream; and
(p) passing at least a part of the compressed boil-off gas stream to the fuel gas header as ethane-depleted header feed stream.

21. The method of claim 20, comprising a step (o) after step (n) and prior to step (p) wherein step (o) comprises:
(o) heat exchanging the compressed boil-off gas stream against ambient.

22. The method of claim 20, wherein the compressing of the boil-off gas comprises passing the boil-off gas through a boil-off gas compressor and subsequently passing the compressed boil-off gas stream to an intermediate stage of the end-flash compressor to provide the compressed end-flash gas stream.

23. The method of claim 15, further comprising the step of:
(q) firing at least one gas turbine with at least one turbine fuel gas stream to provide at least one turbine flue gas stream and generate at least one of electrical power and mechanical power, wherein the at least one turbine fuel gas stream comprises the at least one fuel gas stream.

24. The method of claim 23, further comprising the step of:
(r) driving a compressor with the at least one of said electrical power and mechanical power generated in step (q).

25. The method of claim 24, wherein the compressor is comprised in a refrigerant circuit, further comprising a step of circulating the at least one refrigerant stream of step (c) in the refrigerant circuit comprising compressing an at least partially evaporated refrigerant stream with the compressor.

26. The method of claim 23, further comprising the step of passing at least one turbine flue gas stream to a combustion device to increase the flue gas temperature to provide at least one heated turbine flue gas stream.

27. The method of claim 15, further comprising the steps of:
(s) combusting the at least one fuel gas stream in at least one boiler to provide at least one boiler flue gas stream; and
(t) heat exchanging the at least one boiler flue gas stream against a water stream to provide at least one steam stream and at least one cooled flue gas stream.

28. The method of claim 15, wherein said separating the hydrocarbon feed stream in said at least one separator in step (b) comprises the steps of:
(b1) separating the hydrocarbon feed stream in a first separator to provide a methane-lean stream and the hydrocarbon stream in the form of a methane-rich stream; and
(b2) separating the methane-lean stream in a second separator to provide the first ethane-rich header feed stream and at least one ethane-lean stream.

29. The method of claim 15, wherein the at least one refrigerant stream is circulated in at least one refrigerant circuit, the at least one refrigerant circuit comprising at least one compressor, at least one cooler, at least one expansion device, and at least one heat exchanger, said method further comprising the steps of:
(u) compressing at least a fraction of the at least one at least partially evaporated refrigerant stream in the at least one refrigerant compressor to provide at least one compressed refrigerant stream;
(v) cooling the at least one compressed refrigerant stream in the at least one cooler to provide at least one cooled refrigerant stream; and
(w) expanding at least a fraction of the at least one cooled refrigerant stream in the at least one refrigerant expansion device to provide at least one refrigerant stream.

30. The method of claim 15, wherein the hydrocarbon stream comprises natural gas.

31. An apparatus for cooling a hydrocarbon stream, the apparatus comprising at least:
at least one separator arranged to receive the hydrocarbon feed stream in a hydrocarbon feed stream line and to separate the hydrocarbon feed stream to provide a hydrocarbon stream in a hydrocarbon stream line and a first ethane-rich header feed stream in a first ethane-rich header feed stream line;
at least one heat exchanger arranged to receive the hydrocarbon stream in a hydrocarbon stream line and a refrigerant stream in a refrigerant stream line to heat exchange the hydrocarbon stream against the refrigerant stream to provide a cooled hydrocarbon stream in a cooled hydrocarbon stream line and an at least partly evaporated refrigerant stream in an at least partly evapourated refrigerant stream line; and
at least one fuel gas header connected to the first ethane-rich header feed stream line to receive the first ethane-rich header feed stream, said at least one fuel gas header being connected to at least one fuel gas stream line to provide at least one fuel gas stream.

32. The apparatus according to claim 31, wherein the hydrocarbon stream comprises natural gas, and wherein the at least one separator comprises:
a first separator in the form of a demethanizer, arranged to receive the hydrocarbon feed stream and separate the hydrocarbon feed stream into the hydrocarbon stream in the form of a methane-rich stream and a methane-lean stream, and
a second separator in the form of a deethanizer, arranged to receive the methane-lean stream and separate the methane-lean stream into the first ethane-rich header feed stream and at least one ethane-lean stream.

33. The apparatus according to claim 31, further comprising at least one of a gas turbine and a boiler, fired using at least one turbine fuel gas stream, respectively boiler fuel gas stream, that comprises the at least one fuel gas stream.

34. The apparatus according to claim 31, further comprising:
a second ethane-rich fuel gas feed line for a second ethane-rich fuel gas stream connecting the hydrocarbon feed stream line to the at least one fuel gas header to pass at least a portion of the hydrocarbon feed stream to the at least one fuel gas header.

35. The apparatus according to claim 31, further comprising:
at least one gas turbine fired with at least one turbine fuel gas stream to provide at least one turbine flue gas stream and generate at least one of electrical power and mechanical power, wherein the at least one turbine fuel gas stream comprises the at least one fuel gas stream;
a compressor driven with the at least one of said electrical power and mechanical power;
a refrigerant circuit comprising the compressor and the refrigerant stream line with the refrigerant stream.

36. The apparatus according to claim 31, further comprising:
an expansion device connected to the cooled hydrocarbon stream line to expand the cooled hydrocarbon stream to provide an expanded cooled hydrocarbon stream in an expanded cooled hydrocarbon stream line;
an end gas/liquid separator connected to the expanded cooled hydrocarbon stream line to separate the expanded cooled hydrocarbon stream into an end-flash gas stream in an end-flash gas stream line and a liquid bottom stream in a liquid bottom stream line;
an end-flash compressor connected to the end-flash gas stream line to compress the end-flash gas stream to provide a compressed end-flash gas stream in a compressed end-flash gas stream line;
an end-flash gas cooler connected to the compressed end-flash gas stream line to cool the end-flash gas stream to provide a cooled end-flash gas stream in a cooled end-flash gas stream line; and
a third ethane-rich fuel gas feed line connecting the cooled end-flash gas stream line to the at least one fuel gas header to pass at least a portion of the cooled end-flash gas stream to the at least one fuel gas header.
